(19) United States
(12) Patent Application Publication
(10) Pub. No.: US 2015/0138958 A1
(43) Pub. Date: May 21, 2015

(54) SYSTEM AND METHOD TO SEND OAM PACKETS ON REDUNDANCY PATHS

(71) Applicant: Mingchao Shao, Rockville, MD (US)

(72) Inventor: Mingchao Shao, Rockville, MD (US)

(73) Assignee: TELEFONAKTIEBOLAGET L M ERICSSON (PUBL), Stockholm (SE)

(21) Appl. No.: 14/391,654

(22) PCT Filed: Apr. 18, 2012
(86) PCT No.: PCT/CN2012/074234

§ 371 Date: Feb. 2, 2015

(51) Int. Cl. H04L 12/707; H04L 12/24

(52) U.S. Cl. CPC H04L 45/22; H04L 41/0654
USPC 370/228

(57) ABSTRACT

An improved system and method for transmitting Operations, Administration, and Maintenance, OAM, messages on in a redundancy path are provided. For each OAM function on a service instance of a redundancy path “1 [symbol] 7 comprising one primary path and one secondary path “1 [symbol] 7 only one OAM endpoint is created. The OAM endpoint can transmit packets over both the primary and secondary paths. The OAM endpoint contains an index to the primary path and a redundancy index which is used to lookup into a redundancy table. Each entry in the redundancy table indicates whether the primary path or the secondary path is active. OAM packets are transmitted on the active path (i.e., primary or secondary). When a switchover between the redundant paths is required (i.e., when a failure or its correction is detected on the primary path), the corresponding redundancy table entry is changed to implement the switchover. In one embodiment, PW OAM over protected LSP is implemented in an MPLS or MPLS-TP network. Only one OAM endpoint is needed for each OAM function on the PW; the OAM endpoint will decide to transmit over primary or secondary LSP based on the redundancy table entry.

### TECHNICAL FIELD

The present invention relates generally to communication networks, and in particular to a system and method of efficiently determining which of redundant paths through a node to utilize for forwarding Operations, Administration, and Maintenance (OAM) packets.

### BACKGROUND

Communication networks are well known and widely deployed. A variety of protocols and technologies have been developed to route data through communication networks, as well as perform “overhead” functions relating to maintenance and management of the network itself. The latter are known in the art generally as Operations, Administration, and Maintenance or Management (OAM) functions.

One example of a communication network data routing protocol is Multiprotocol Label Switching (MPLS), which directs data from node to node within a network based on short path labels rather than long network addresses (e.g., IP addresses), avoiding the need for look-ups into routing tables at each node. MPLS prefixes packets with an MPLS header, which contains one or more labels (known as a label stack). A Label Switched Path (LSP) is a path through an MPLS network defined by a set of labels assigned by each node in the path. An LSP begins at an ingress Label Edge Router (LER), proceed along a plurality of Label Switched Routers (LSR), and terminates at an egress LER. The ingress LER prefixes a label to a data packet, and passes it along to an LSR, which swaps the packet's outer label for another label, and forwards it to the next LSR. The egress LER pops the MPLS label from the packet, and forwards the packet toward a destination based on another protocol (e.g., IPv4 addressing). An LSP is unidirectional, and may include protection against link or node failure (known as linear protection) by provisioning both a primary, or protected LSP, and a secondary, or protection, LSP. Both the primary and secondary LSPs share ingress and egress LERs, but are preferably routed along different LSRs. LSPs can be established statically by configuration of management layers, or dynamically by signaling protocols.

FIG. 1 depicts a representative although greatly simplified MPLS topology. The MPLS topology includes a set of Customer Edge (CE) nodes CE1 and CE2, Label Edge Routers LER1 and LER2 and Label Switched Routers LSR1 and LSR2. At each LER, the traffic from CE nodes will be encapsulated with MPLS labels and transmitted to the peer LER over LSPs. The LSP is configured with linear protection, with a primary LSP traversing through LER1->LSR1->LER2, and secondary LSP traversing through LER1->LSR2->LER2 (similar redundant paths may be defined in the reverse direction).

The Transport Profile of Multiprotocol Label Switching (MPLS-TP) is a packet-based transport technology based on the MPLS data plane, which re-uses many aspects of the MPLS management and control planes. LSP is also used by MPLS-TP as transport path for data forwarding.

In an MPLS-TP network, survivability is critical for the delivery of guaranteed network services, such as those subject to strict Service Level Agreements (SLAB) which place maximum bounds on the length of time that services may be degraded or be unavailable. Survivability refers to the ability of the network to recover traffic within a certain time in case of failure of the transport path that is used to deliver service. The failure of a LSP can be caused by the failure of a link or node, or a partial node failure (e.g., one or more line cards in a node, such as an LER). When linear protection is employed by configuring primary and secondary LSPs between the same LERs, if an LER includes multiple line cards, it is preferred to originateterminate the secondary LSP on a different line card than the primary LSP, to achieve higher survivability in case there is a failure or scheduled maintenance on a line card.

Pseudo-Wire (PW) is the emulation of a point-to-point connection (i.e., a wire) over a packet-switching network. PW may be implemented in MPLS-TP networks. Such a PW implementation may emulate a variety of data transfer protocols, such as Ethernet, Time-Division Multiplexing (TDM), Asynchronous Transfer Mode (ATM), and the like. OAM functions may also be configured over a PW, such as PW status signaling (see IETF draft-ietf-pwe3-static-pw-status-09, Pseudowire Status for Static Pseudowires, available at http://tools.ietf.org/html/draft-ietf-pwe3-static-pw-status-09) and Bidirectional Forwarding Detection (BFD).

If a PW is transmitted over a linear primary LSP, and the secondary LSP originates on a different line card than the primary LSP in a LER, PW OAM endpoints must be created on both line cards to terminate the primary (protected) and secondary (protection) LSPs.

FIG. 2 depicts a conventional LER node 10, configured for transmitting OAM on redundancy LSPs. The node 10 has one control board 12 and four line cards 20a-20d. The control board includes a CPU 14 and switching fabric 16. Each of the line cards 20a-20d includes a CPU 22, OAM engine 24 and forwarding chip 26. The control board CPU 14 is operative to communicate with the line card CPUs 22; they can exchange control and management messages. The forwarding chips 26 are connected to the switching fabric 16 on the control board 10. The switching fabric 16 receives packets from, and forwards packets to, forwarding chips 26 on the line cards 20a-20d.

A primary LSP is configured on line card 20c, and its secondary LSP is configured on line card 20d. To transmit PW OAM packets, OAM endpoints must be created by the OAM engines 24 on both line cards 20c and 20d; however, only one of these OAM endpoints may be active at a time. Initially, only the PW OAM endpoint on line card 20c will be used to transmit and receive PW OAM packets on the primary LSP. During this time, the PW OAM endpoint on line card 20d must not be transmitting or receiving OAM packets on the secondary LSP; otherwise, the other end of the LSP could receive duplicated OAM packets.

When a failure is detected on the primary LSP, the PW traffic is switched over to the secondary LSP. The PW OAM endpoint on line card 20d must be activated to transmit and receive OAM packets on the secondary LSP. The PW endpoint on line card 20c must be deactivated to stop transmitting or receiving OAM packets on the primary LSP. That is, only one of the two PW OAM endpoints can be active at a time.

Conventional PW OAM implementation on MPLS-TP, as depicted in FIG. 2, is deficient in at least two respects. First, the PW OAM endpoint on line card 20d (the secondary LSP) is a waste of resources. Normally, the number of OAM endpoints supported by line card is limited, and there are many different OAM functions competing for this limited number of OAM endpoints. Second, the status of PW OAM endpoints on two different line cards 20c and 20d must be coordinated. Only one of these OAM endpoints can be activated at a time, otherwise the other end may receive duplicated OAM messages. This coordination and synchronization represents additional overhead that must be performed by the LER node 10 (e.g., the control board CPU 14).

The Background section of this document is provided to place embodiments of the present invention in technological and operational context, to assist those of skill in the art in understanding their scope and utility. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure, and is not intended to identify keycritical elements of embodiments of the invention or delineate the scope of the invention. The sole purpose of this summary is to present some concepts disclosed herein in a simplified form as a prelude to the more detailed description that is presented later.

One or more embodiments described and claimed herein provide an improved system and method for transmitting OAM messages on a redundancy path. For each OAM function on a service instance of a redundancy path comprising one primary path and one secondary path—only one OAM endpoint is created. The OAM endpoint can transmit packets over both the primary and secondary paths. The OAM endpoint contains an index to the primary path and a redundancy index which is used to lookup into a redundancy table. Each entry in the redundancy table indicates whether the primary path or the secondary path is active. OAM packets are transmitted on the active path (i.e., primary or secondary). When a switchover between the redundant paths is required (i.e., when a failure or its correction is detected on the primary path), the corresponding redundancy table entry is changed to implement the switchover. In one embodiment, PW OAM over protected LSP is implemented in an MPLS or MPLS-TP network. Only one OAM endpoint is needed for each OAM function on the PW; the OAM endpoint will decide to transmit over primary or secondary LSP based on the redundancy table entry.

One embodiment relates to a method of transmitting OAM packets associated with one or more OAM functions, the OAM transmissions having redundant paths, from a node operative in a data communication network. The node has a single OAM endpoint. A need to transmit an OAM packet from the node is determined. Whether redundant paths are configured for the corresponding OAM function is determined. If redundant paths are configured for the OAM function, whether a primary path or a secondary path is active for the OAM function is determined. The OAM packet is transmitted on the primary path or the secondary path in response to determining which redundant path is active.

Another embodiment relates to a node operative in a data communication network. The node is operative to transmit OAM packets associated with one or more OAM functions on redundant paths. The node includes a control board having a processor and an OAM engine. The OAM engine is controlled by the control board processor, and is operative to implement a single OAM endpoint, and to maintain an OAM table and redundancy table. The OAM engine is also operative to determine a need to transmit an OAM packet from the node; determine whether redundant paths are configured for the corresponding OAM function; if redundant paths are configured for the OAM function, determine whether a primary path or a secondary path is active for the OAM function; and transmit the OAM packet on the primary path or the secondary path in response to determining which redundant path is active.

### BRIEF DESCRIPTION OF THE DRAWINGS

FIG. 1 is a block diagram of a conventional MPLS communication network topology.

FIG. 2 is a functional block diagram of a conventional Label Edge Router.

FIG. 3 is a functional block diagram of a Label Edge Router according to one embodiment of the present invention.

FIG. 4 is a diagram of an OAM table entry.

FIG. 5 is a diagram of a redundancy table.

FIG. 6 is a flow diagram of a method of transmitting OAM packets on redundant paths.

FIG. 7 is a diagram of an intermediate packet.

FIG. 8 is a diagram of an encapsulation table.

FIG. 9 is a diagram of an output data packet.

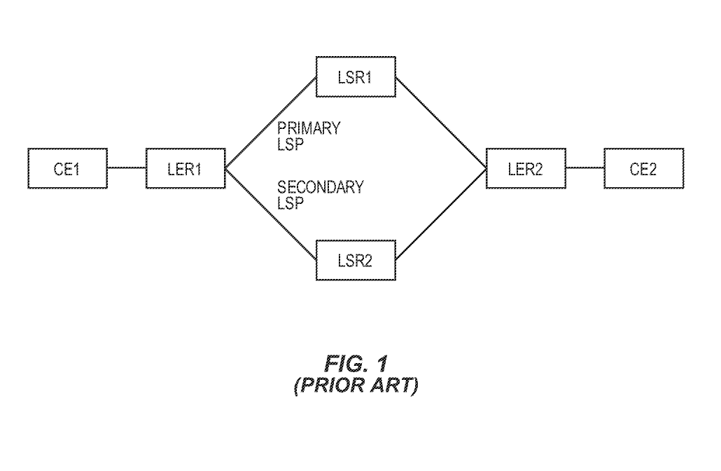

### DETAILED DESCRIPTION

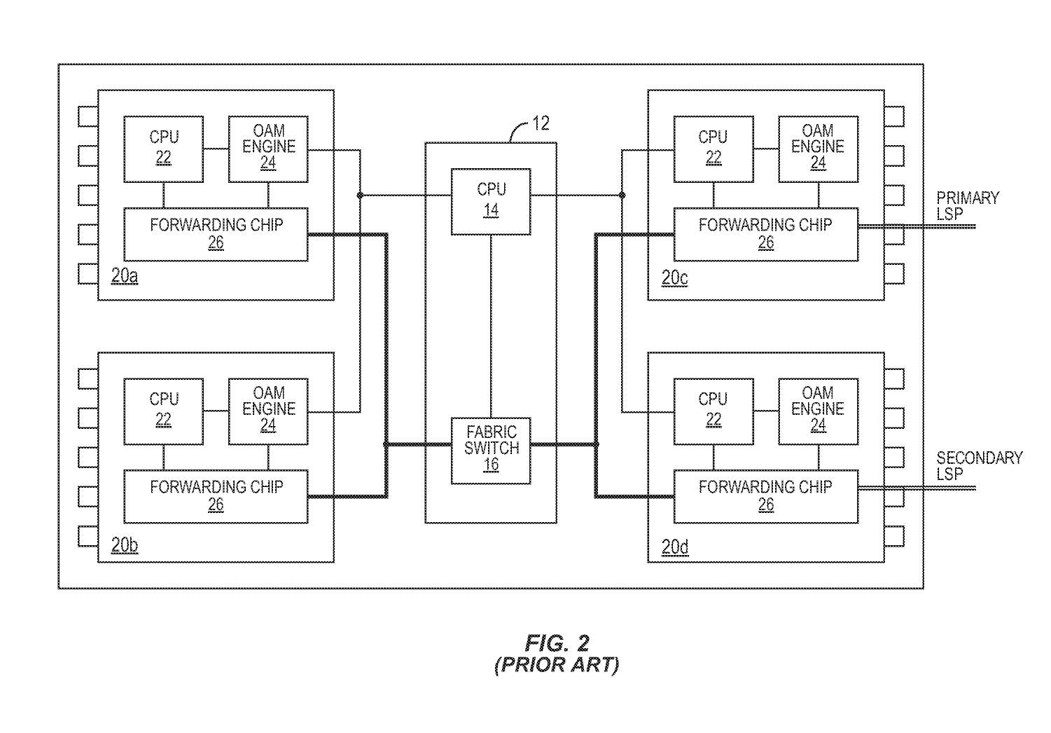

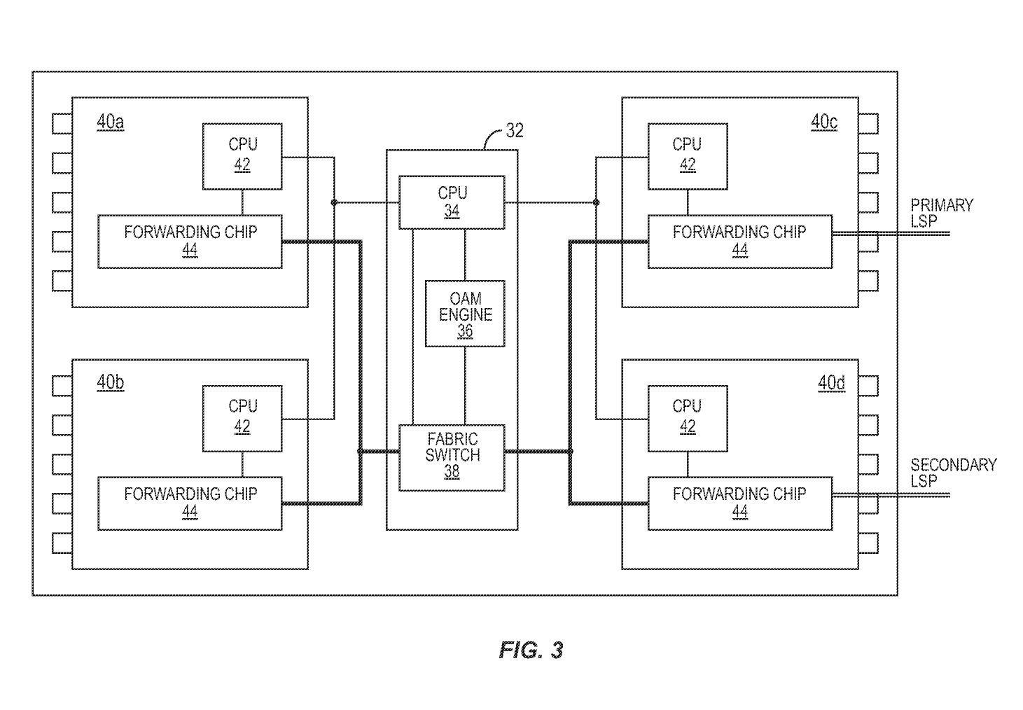

FIG. 3 depicts a LER node 30 according to one embodiment of the present invention. The LER 30 is configured for efficiently transmitting OAM on redundancy LSPs particularly during a primary-to-secondary path (or the reverse) switchover. The node 30 includes a control board 32 and four line cards 40a-40d. The control board includes a CPU 34, an OAM engine 36, and a switching fabric 38. Each of the line cards 40a-40d includes a CPU 44 and a forwarding chip 46. Note that compared to the conventional LER node 10 depicted in FIG. 2, the LER node 30 depicted in FIG. 3 includes only one OAM engine 36, centrally located on the control board 32. Each line card 40a-40d does not need to implement an OAM engine. As described further herein, this feature represents a significant reduction in complexity and overhead processing when switching OAM packet routing between primary and secondary LSRs.

The control board CPU 34 is operative to communicate with the line cards CPUs 44; they can exchange control and management messages. The forwarding chips 46 are connected to the switching fabric 38 on the control board 30. The switching fabric 38 receives packets from, and forwards packets to, forwarding chips 44 on the line cards 40a-40d, under the control of the single OAM engine 36.

A primary LSP is configured on line card 40c, and its secondary LSP is configured on line card 40d. According to one embodiment of the present invention, to transmit PW OAM packets over the redundancy LSPs, only one OAM endpoint needs to be created in the OAM engine 36 of the control board 32. The OAM engine manages one OAM table to store the configuration of all the OAM endpoints, and one redundancy table to store redundancy status for all redundancy paths in the node. For each of the OAM endpoints that is, for each active OAM function there is one entry in the OAM table containing the configuration of the OAM endpoint, and this OAM entry contains one redundancy index used to lookup into the redundancy table to get the redundancy status. Each pair of redundancy LSP will have one redundancy entry allocated in the redundancy table, and several pairs of redundancy LSP can share the same redundancy entry if they are in the same shared risk group, i.e., they always switch over at the same time.

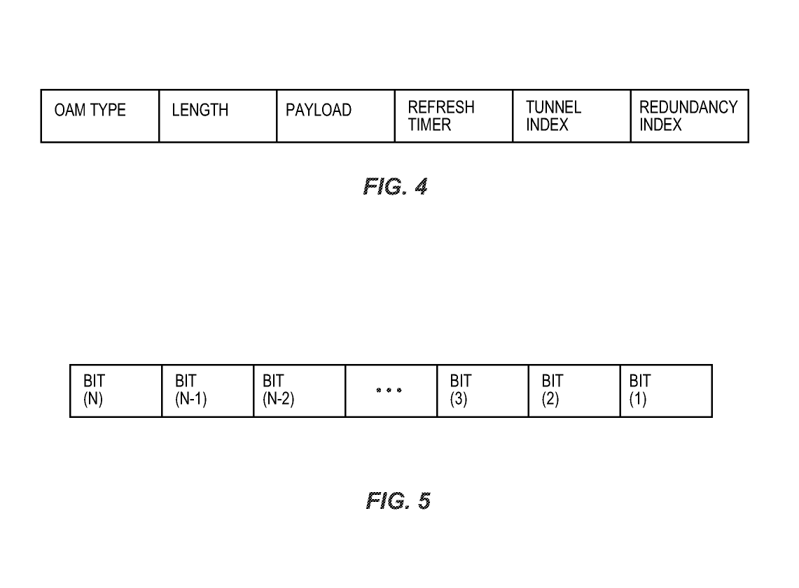

FIG. 4 depicts an entry in one embodiment of the OAM table used to store OAM endpoints configurations. The OAM TYPE field is used to indicate the type of the OAM endpoint, e.g., BFD, PW static status signaling, and the like. The LENGTH field is the length of the OAM PAYLOAD. PAYLOAD is the content of the OAM packets to be transmitted. REFRESH TIMER is the interval between two consecutive OAM packets transmitted by the OAM engine for the endpoint. TUNNEL INDEX is used to control switching through the switching fabric 38. REDUNDANCY INDEX is an index into a redundancy table. The entries in the OAM table are configured by the CPU 34 when an OAM endpoint is created. The OAM TYPE field will be set to a value indicating “invalid” when the OAM endpoint is deleted by the CPU 34.

FIG. 5 depicts one embodiment of the redundancy table used to store redundancy status of the redundancy paths. In this embodiment, the redundancy table is a bit array indexed by the redundancy index. For example, bit N in the redundancy table corresponds to the redundancy index N. In normal conditions, bit N is set to 0. When there is a switchover from the primary to the secondary LSP, the bit N will be flipped to 1 by the CPU 34, indicating that the secondary path should be used to transmit PW OAM packets. When traffic is restored from the secondary LSP to the primary LSP, the bit N will be flipped to 0 by the CPU 34, and the primary path will be used to transmit PW OAM packets. In this manner, a single bit in a lookup table controls whether the primary or secondary path is used to transmit OAM packets. Separate OAM endpoints are not necessary for the primary and secondary paths. Additionally, an OAM engine for the primary path does not need to be shut down and an OAM engine for the secondary path started when a switchover occurs, such as upon detection of a failure on the primary path (or vice versa when the traffic switches back to the primary path).

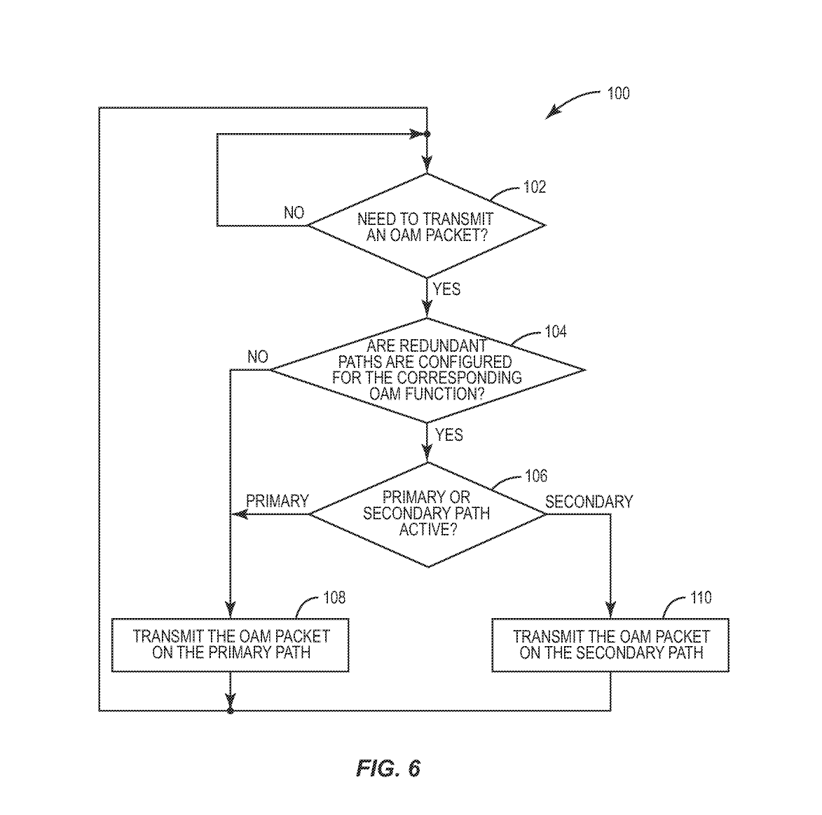

FIG. 6 depicts a method 100 of transmitting an OAM packet associated with an OAM function, wherein the OAM transmission has redundant paths and only a single OAM endpoint is required. Initially, the OAM engine 36 determines whether a need exists to transmit an OAM packet (block 102). In one embodiment, this determination is made upon receipt of a trigger event, such as the expiration of a refresh timer. For example, a timer may expire periodically (e.g., every 1 msec), triggering a procedure to loop through all OAM entries in the OAM table, inspecting values in the REFRESH TIMER field. If the REFRESH TIMER value has elapsed since the last time of expiration, an OAM packet should be transmitted for the associated OAM function. That is, the REFRESH TIMER value is the interval between two consecutive OAM packets transmitted by the OAM engine for the endpoint.

When the OAM engine 36 determines that an OAM packet is to be transmitted for an OAM function (block 102), it determines whether redundant paths are configured for the OAM function (block 104). In one embodiment, this comprises inspecting the redundancy index in the OAM table entry. If the redundancy index is a predetermined value, e.g., zero, then no redundant paths are configured. If the redundancy index is a different, e.g., non-zero, value, then redundant paths are configured, and the OAM engine 36 proceeds to determine whether the primary or secondary path is active (block 106). In one embodiment, this determination is made by a lookup into the redundancy table, using the redundancy index obtained from the OAM entry.

In one embodiment, as described above, the redundancy table comprises a bit array. Thus, a table lookup using the redundancy index will return a single bit value. In one embodiment, a redundancy bit value of 0 indicates that the primary path is active, and the OAM engine transmits the OAM packet on the primary path (block 108). In this embodiment, a redundancy bit value of 1 indicates that the secondary path is active, and the OAM engine transmits the OAM packet on the secondary path (block 108). Of course, in other embodiments, the meanings of the bit values may be reversed, or the redundancy table entries may comprise values greater than one bit.

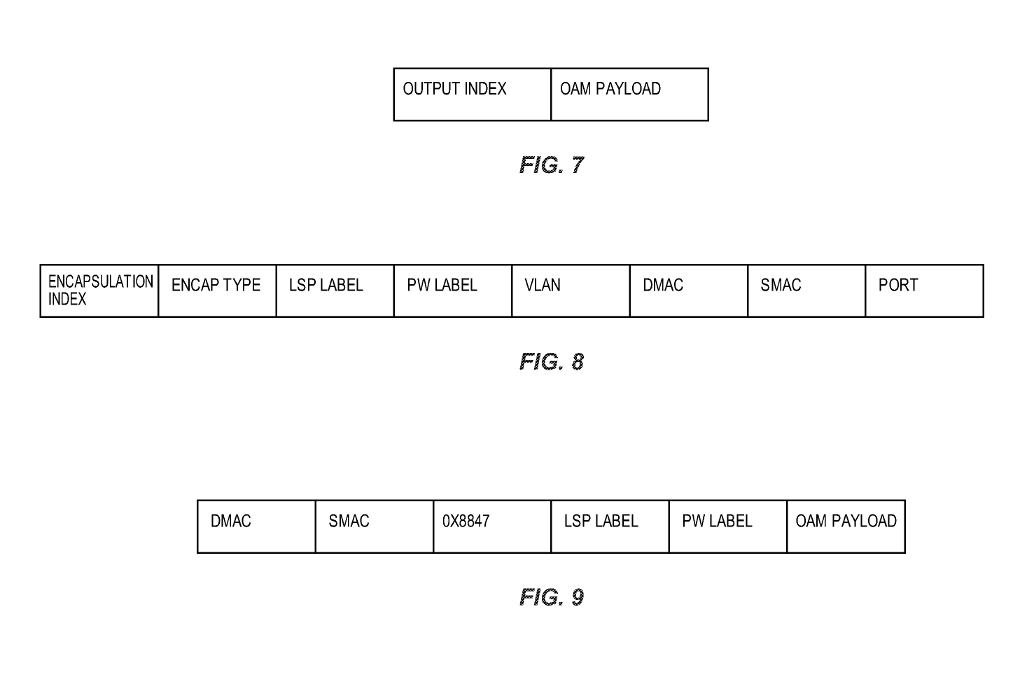

In either case (primary or secondary path is active), the OAM engine transmits the OAM packet by creating an intermediate packet comprising an OUTPUT INDEX and the OAM PAYLOAD, as depicted in FIG. 7. The OAM PAYLOAD is obtained from the corresponding field of the OAM entry in the OAM table. In one embodiment, if the primary path is active, the OUTPUT INDEX is simply the TUNNEL INDEX obtained from the OAM entry in the OAM table. Alternatively, it may be a value created from the TUNNEL INDEX, such as by adding a fixed offset thereto, or some other predefined formula, depending on the allocation algorithm of the OUTPUT INDEX in the switching fabric 38. In one embodiment, if the secondary path is active, the OUTPUT INDEX is a fixed offset from the TUNNEL INDEX value, e.g., (TUNNEL INDEX+1). However calculated, the OUTPUT INDEX is used by the switching fabric 38 to determine to which forwarding chip 44 the OAM packet shall be sent. In normal operating conditions, the OAM packet will be sent to the forwarding chip 44 where the primary LSP is hosted (i.e., line card 40c of the LER 30 depicted in FIG. 3). If switchover to the secondary LSP occurred, the OAM packet will be sent to the forwarding chip 44 where the secondary LSP is hosted (i.e., line card 40d).

At the relevant forwarding chip 44, the OAM packet is encapsulated for transmission into the network using an encapsulation table maintained by the forwarding chip 44. FIG. 8 depicts a representative entry of an encapsulation table. The encapsulation table is indexed by an ENCAPSULATION INDEX, which is derived from the OUTPUT INDEX in the header of the intermediate packet received from the switching fabric 38. Each entry in the encapsulation table contains all the information needed to send the packets out on the physical link. These fields may vary by implementation and the operative communication protocols, but may for example include the ENCAP TYPE to indicate the type of the encapsulation; the LSP and PW LABELs; an optional VLAN tag; the destination and source MAC addresses; and a physical port number.

The encapsulation process at the forwarding chip 44 produces an output packet, such as the one depicted in FIG. 9. The output packet includes all fields necessary for routing in the network, and the payload. As a representative example, the output packet depicted in FIG. 9 includes the source and destination MAC addresses DMAC and SMAC; LSP LABEL; and PseudoWire (PW) LABEL from the encapsulation table entry in the forwarding chip 44, and the OAM PAYLOAD from the OAM table in the OAM engine 36. Implementation-specific fields, such as predefined hex values, may be included.

Embodiments of the present invention present numerous advantages over OAM packet transmission according to the prior art. For example, system scalability is improved by reducing the number of OAM endpoints required to transmit OAM packets over redundancy paths. Additionally, system robustness is improved and system design is simplified by eliminating the requirement to coordinate between OAM endpoints during switchovers between primary and secondary paths.

Although described herein with reference to the MPLS and MPLS-TP protocols, the present invention is not so limited, and is in fact applicable in any network node where OAM packets are transmitted on redundant paths. Those of skill in the art will readily recognize that various embodiments of the present invention have been described separately and independently herein for clarity of understanding. In practice, features of the various embodiments may be combined in appropriate implementations, as may be readily determined by those of skill in the art without undue experimentation, given the teachings of the present disclosure. Furthermore, the invention is not limited to the disclosed embodiments.

The CPUs 34, 42 may comprise any sequential state machine operative to execute machine instructions stored as machine-readable computer programs in memory, such as one or more hardware-implemented state machines (e.g., in discrete logic, FPGA, ASIC, etc.); programmable logic together with appropriate firmware; one or more stored-program, general-purpose processors, such as a microprocessor or Digital Signal Processor (DSP), together with appropriate software; or any combination of the above.

The OAM table, redundancy table, and encapsulation table are preferably implemented in machine-readable memory. Those of skill in the art also readily recognize that memory is necessary for operation of the CPUs 34, 42. Such memory may comprise any non-transient machine-readable media known in the art or that may be developed, including but not limited to magnetic media (e.g., floppy disc, hard disc drive, etc.), optical media (e.g., CD-ROM, DVD-ROM, etc.), solid state media (e.g., SRAM, DRAM, DDRAM, ROM, PROM, EPROM, Flash memory, etc.), or the like.

Those of skill in the art will recognize that the OAM engine 36 is a functional block, which may be implemented in hardware, programmable logic together with appropriate firmware, or as one or more software modules executable on the CPU 34 or other computational device.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1. A method of transmitting Operations, Administration, and Maintenance, OAM, packets associated with one or more OAM functions, the OAM transmissions having redundant paths, from a node operative in a data communication network, the node having a single OAM endpoint, the method comprising:
determining a need to transmit an OAM packet from the node;
determining (104), at a single OAM endpoint, whether redundant paths are configured for the corresponding OAM function;
if redundant paths are configured for the OAM function, determining whether a primary path or a secondary path is active for the OAM function; and
transmitting the OAM packet on the primary path or the secondary path in response to determining which redundant path is active.

2. The method of claim 1, further comprising:
accessing an OAM table comprising one or more entries, each entry associated with an OAM function and including at least a refresh timer value and a redundancy index.

3. The method of claim 2, wherein determining a need to transmit an OAM packet from the node comprises:
receiving a trigger event; and
in response to the trigger event, determining the need to transmit an OAM packet for each of one or more OAM functions;

4. The method of claim 3, wherein the trigger event is a timer reaching a predetermined value, and wherein determining the need to transmit an OAM packet for each of one or more OAM functions comprises:
in response to the timer event, cycling through one or more entries in the OAM table; and
determining the need to transmit an OAM packet for an OAM function in response to the refresh timer value in the corresponding OAM table entry.

5. The method of claim 2, wherein determining whether redundant paths are configured for the OAM function comprises assessing the value of the redundancy index in the corresponding OAM table entry.

6. The method of claim 5, wherein determining whether the primary path or the secondary path is active for the OAM function comprises indexing a redundancy table with the redundancy index retrieved for the OAM function and determining whether the primary or secondary path is active in response to the value retrieved from the redundancy table.

7. The method of claim 2, wherein each OAM table entry further comprises a tunnel index and an OAM payload, and wherein transmitting the OAM packet on the primary path comprises:
calculating an output index based on the tunnel index retrieved from the corresponding OAM table entry;
forming an intermediate packet comprising the output index and the OAM payload retrieved from the corresponding OAM table entry; and
forwarding the intermediate packet to a switching fabric on the node for distribution to a forwarding chip on the node.

8. The method of claim 7, wherein transmitting the OAM packet on the secondary path further comprises incrementing the tunnel index by one prior to calculating an output index.

9. The method of claim 7, further comprising:
forwarding the intermediate packet from a switching fabric to a forwarding chip based on the output index of the intermediate packet;
accessing an encapsulation table comprising one or more entries, each entry associated with an OAM function and including at least source and destination network addresses;
encapsulating the intermediate packet into an output packet including at least source and destination network addresses retrieved from the encapsulation table and the OAM payload retrieved from the intermediate packet; and
transmitting the output packet from the node into the communication network.

10. The method of claim 2, wherein each OAM table entry further includes an OAM type value, and further comprising, when an OAM function is added to the OAM endpoint:
creating an OAM table entry, having a unique OAM type value, for each active OAM function.

11. The method of claim 10 further comprising, when an OAM function is deleted from the OAM endpoint:
setting the OAM table entry for the corresponding OAM function to value indicating the entry is invalid.

12. A node operative in a data communication network, and further operative to transmit Operations, Administration, and Maintenance, OAM, packets associated with one or more OAM functions, on redundant paths, the node comprising:
a control board including a processor and an OAM engine;
wherein the OAM engine is controlled by the control board processor and is operative to implement a single OAM endpoint and to maintain an OAM table and redundancy table, and further operative to
determine a need to transmit an OAM packet from the node;
determine whether redundant paths are configured for the corresponding OAM function;
if redundant paths are configured for the OAM function, determine whether a primary path or a secondary path is active for the OAM function; and
transmit the OAM packet on the primary path or the secondary path in response to determining which redundant path is active.

13. The node of claim 12, wherein each entry in the OAM table is associated with an OAM function and includes at least a refresh timer value and a redundancy index.

14. The node of claim 13, wherein the OAM engine is operative to determine a need to transmit an OAM packet by:
receiving a trigger event; and
in response to the trigger event, determining the need to transmit an OAM packet for each of one or more OAM functions;

15. The node of claim 14, wherein the trigger event is a timer reaching a predetermined value, and wherein the OAM engine is operative to determine the need to transmit an OAM packet for each of one or more OAM functions by
in response to the timer event, cycling through one or more entries in the OAM table; and
determining the need to transmit an OAM packet for an OAM function in response to the refresh timer value in the corresponding OAM table entry.

16. The node of claim 13, wherein the OAM engine is operative to determine whether redundant paths are configured for the OAM function by assessing the value of the redundancy index in the corresponding OAM table entry.

17. The node of claim 16, wherein the OAM engine is operative to determine whether the primary path or the secondary path is active for the OAM function by indexing a redundancy table with the redundancy index retrieved for the OAM function and determining whether the primary or secondary path is active in response to the value retrieved from the redundancy table.

18. The node of claim 13, further comprising:
a plurality of line cards communicatively coupled to the control board, each line card including a processor communicatively coupled to the control board processor and a forwarding chip; and
a switching fabric operative on the control board to direct data packets between each line card forwarding chip; and
wherein each OAM table entry further comprises a tunnel index and an OAM payload, and wherein the OAM engine is operative to transmit the OAM packet on the primary path by
calculating an output index based on the tunnel index retrieved from the corresponding OAM table entry;
forming an intermediate packet comprising the output index and the OAM payload retrieved from the corresponding OAM table entry; and
forwarding the intermediate packet to the switching fabric for distribution to a forwarding chip.

19. The node of claim 18, wherein the OAM engine is operative to transmit the OAM packet on the secondary path by further incrementing the tunnel index by one prior to calculating an output index.

20. The node of claim 18, wherein the OAM engine is further operative to
cause the switching fabric to forward the intermediate packet to a forwarding chip based on the output index of the intermediate packet; and
cause the forwarding chip to
access an encapsulation table comprising one or more entries, each entry associated with an OAM function and including at least source and destination network addresses;
encapsulate the intermediate packet into an output packet including at least source and destination network addresses retrieved from the encapsulation table and the OAM payload retrieved from the intermediate packet; and
transmit the output packet from the node into the communication network.

21. The node of claim 13, wherein each OAM table entry further includes an OAM type value, and wherein, when an OAM function is added to the OAM endpoint, the control board processor is operative to create an OAM table entry, having a unique OAM type value, for each active OAM function.

22. The node of claim 21, wherein, when an OAM function is deleted from the OAM endpoint, the control board processor is operative to set the OAM table entry for the corresponding OAM function to a value indicating the entry is invalid.
